(19) United States
(12) Patent Application Publication
(10) Pub. No.: US 2010/0288059 A1
(43) Pub. Date: Nov. 18, 2010

(54) SPECIMEN CONTAINER, SYSTEM, AND METHOD

(75) Inventors: Hendrik J. Viljoen, Lincoln, NE (US); Scott E. Whitney, Lincoln, NE (US); Joel R. Termaat, Lincoln, NE (US); Alison Freifeld, Omaha, NE (US)

Correspondence Address: DOBRUSIN & THENNISCH PC, 29 W LAWRENCE ST, SUITE 210, PONTIAC, MI, 48342, US

(73) Assignee: STRECK, INC., LaVista, NE (US)

(21) Appl. No.: 12/780,508

(22) Filed: May 14, 2010

Related U.S. Application Data
(60) Provisional application No. 61/216,225, filed on May 14, 2009.
(60) Provisional application No. 61/216,360, filed on May 15, 2009.

(51) Int. Cl. G01N 1/12; B01L 3/00

(52) U.S. Cl. 73/864.51; 422/102

(57) ABSTRACT

This invention relates to the collection and handling of biological or chemical specimens. The invention provides a device and a method for collecting and preparing patient samples, such as sputum, to be used in downstream diagnostics tests. The invention reduces the handling and exposure of healthcare workers to the sample by the use of a bag in which hermetic seals are utilized to separate sample aliquots.

### CROSS REFERENCE TO RELATED APPLICATION

This U.S. Application is related to PCT Application Serial No. PCT/US2010/______, and U.S. application Ser. No. 12/______, both filed May 14, 2010, to Viljoen et al., and entitled SAMPLE PROCESSING CASSETTE, SYSTEM, AND METHOD; and is related to PCT Application Serial No. 12/______, filed May 14, 2010, to Viljoen et al., and entitled SPECIMEN CONTAINER, SYSTEM, AND METHOD, the entirety of the contents of these applications being incorporated by reference herein for all purposes.

### CLAIM OF PRIORITY

This application claims the benefit of the filing date of U.S. Provisional Application Ser. No. 61/216,225, filed on May 14, 2009, entitled SAMPLE SEPARATION DEVICE, SYSTEM AND METHOD, to Viljoen et al.; and U.S. Provisional Application Ser. No. 61/216,360, filed on May 15, 2009, entitled SAMPLE PROCESSING CASSETTE, SYSTEM, AND METHOD, to Viljoen et al.; the entirety of the contents of the applications being incorporated by reference herein for all purposes.

### FIELD

This present disclosure relates to a sample or specimen container for use in collecting, processing and analyzing source materials, such as a biological or chemical specimen.

### BACKGROUND

The collection and analysis of a source material, such as a biological fluid specimen, may be done for a variety of reasons from diagnosis of diseases to the detection of drugs or other substances. Generally, the collection and analysis of a source material such as blood or urine is typically initiated by collecting the specimen in a hard container typically made of a glass or plastic material. The collection and testing of a source material presents a number of challenges, especially in locations without sufficient health and laboratory facilities. Even in highly developed communities, the fragile or hazardous nature of many types of source materials require that the materials are either tested immediately or preserved until arrival at an adequate laboratory facility. Various clinical situations require a sample of a collected specimen to be isolated for use. For example, specimens are routinely collected at a point-of-care clinic where patients are suspected to have communicable disease. Often multiple tests are performed on the collected specimen. As a result, the collected specimen must be divided into multiple samples for the different tests as well as for storage for future tests or shipping to a centralized lab. Thus, when a source material cannot be immediately tested, there is a considerable amount of time between source material collection and eventual diagnosis, where an individual may be unknowingly transmitting a disease to others.

Separation of the collected specimen into different portions may generally pose an exposure risk to the health-care worker who handles the collected specimen. In many instances, the specimen may be collected in a cup or bag, and then the health-care worker must fully open the cup or bag and pour, pipette, or scoop out portion(s) of the sample for analysis. Further, this current practice may have a risk of contamination. It is desirable to reduce or eliminate such risks of exposure and contamination.

An example of where the present invention according to the disclosure is particularly useful is in the collection of specimens from a population where the patients are suspected of having tuberculosis. Typically, sputum is collected from the patient in a collection bag, and the health-care worker must be exposed to an open bag filled with potentially hazardous tuberculosis bacilli to conduct analysis of the specimen. In the present invention, multiple portions of the specimen may be separated into compartments for immediate testing or preservation while reducing the exposure during this step. For example, multiple compartments could be specified for use in typical diagnostics tests and optimized (e.g. for handling and sample volume) given consideration to the downstream tests to be performed. In one known alternative (U.S. Pat. No. 5,423,792) there is disclosed a fluid specimen plastic container for holding a biological fluid specimen wherein the container has a port opening for receipt of the specimen, means for mechanically sealing the container including a sealable cap, a heat seal, or a plug, with the specimen therein, and wherein the seal is effected after receipt of the specimen and can include formation of more than one sealed compartments for subsequent separation and analysis and at least one of the sealed compartments having a rigid or semi rigid element therein protruding from a hole in the compartment to dispense the specimen contained therein, and the container also has an identification element capable of inscription thereon.

Without sufficient laboratory capabilities, disease diagnosis is generally facilitated by obtaining a biological or chemical specimen from a patient at a point-of-care facility and then sending the specimen to a centralized laboratory for testing. During transfer, specimen samples, may degrade or be damaged which jeopardizes or compromises the integrity of the diagnostic results. Even if a specimen is received in an acceptable condition, days or even months may pass before a patient receives the results of the laboratory test of the specimen. In remote developing areas, it may be difficult, or even impossible, to locate and notify the patient of a positive diagnosis, only adding to the difficulty of controlling the spread of communicable diseases in these areas, particularly diseases that are more easily spread through human to human contact or interaction.

Despite the significant advances made in many developed countries to control and even eradicate certain diseases, controlling the spread of certain diseases remains a serious issue. One particular concern is the troubling high rates of tuberculosis that remain in many areas. The spread of tuberculosis in some regions continues as a serious issue given the ease with which the disease is transmitted and the vast number of individuals who are carriers of the disease but are asymptomatic. Tuberculosis is generally an airborne bacterium that is easily spread through close contact, making effective prevention of the spread of the disease nearly impossible.

As an added difficulty, the standard tests for tuberculosis diagnosis in many areas include smear microscopy and mycobacterial culture. While sensitive, culture typically requires six weeks or more to obtain growth and identification of the mycobacteria. While relatively inexpensive, smear microscopy is reported to identify only half the cases of tuberculosis (even less for HIV/AIDS co-infection) and is also unable to identify if a strain is drug-resistant. Thus, the current systems for tuberculosis diagnosis lead to low rates of disease identification in a timely and accurate manner, thereby limiting patient follow-up and proper treatment. These consequences perpetuate not only spread of the disease, but also the development of drug-resistant strains of tuberculosis.

Existing polymerase chain reaction (PCR) technology has also been used for the diagnosis of tuberculosis, but has been hindered by its highly complex preparative steps and long amplification times in the range of hours. In many clinical settings, typical diagnostic methods (including PCR) are comprised of a considerable number of steps and a considerable number of lab devices to prepare and analyze the sample to obtain an actual diagnostic result. While there have been advances in the sample collection to results process (typically by consolidating and automating certain steps), the fact remains that molecular diagnostics are typically confined to high-complexity labs. Even where PCR testing has been shown somewhat effective, most health care facilities cannot support the funding or staffing needs for an operational PCR lab. Additionally, the expense and complexity of conventional PCR technology has prohibited it from being widely applied for diagnosis in areas where tuberculosis is most prevalent. The cost requirements for a high complexity laboratory simply cannot be met in many remote, underdeveloped or economically struggling areas.

In response, there has been a push for point-of-care diagnostic devices that will accurately diagnose tuberculosis while substantially reducing the time required for diagnosis. However, point-of-care diagnostics of tuberculosis pose additional challenges. The risk of infection for any health care worker or lab technician becomes potentially extremely high with tuberculosis samples. Most laboratories that regularly handle infected tuberculosis samples are equipped with fume hoods, biohazard safety cabinets, air sanitation systems or isolated rooms so that anyone in contact with the samples is at least reasonably protected from infection. Health facilities in developing countries that would serve as point-of-care testing locations are simply not equipped with this safety equipment, further increasing the infection risk of health-care workers. Further, current PCR diagnostics requires expensive machinery and/or has slow processing times making existing PCR technology unsuitable for point-of-care use in some areas. Thus, any point-of-care device should also minimize the need for high-technology equipment and technicians.

Notwithstanding the above, there long remains a need for point-of care diagnostic equipment that reduces the risk of infection to healthcare workers, improves the accuracy and speed of diagnostic testing and results, and does so with relatively simplified and lower cost equipment. There is a further remaining need for diagnostic tools that aid in accurate diagnosis while a patient is still at the point-of-care facility so that infected individuals can be treated immediately to help reduce the risk of infecting others. There also remains a need that the diagnoses also provide data regarding drug-resistant strains of a disease so that patients are not treated with a medication that they are resistant to, which will also reduce the risk of transmission to others. There also long remains a need for diagnostic equipment that provides a closed system so healthcare workers will have no direct contact with any specimen. There also long remains a need for diagnostic equipment having low-cost, simplified components so that the equipment can be easily repaired in developing areas.

### SUMMARY

The present disclosure provides for a point-of-care specimen collection device that is useful as part of a method to provide quick and accurate disease diagnosis as part of a closed system having low cost and simplified components. The present disclosure further provides for the collection, treatment and analysis of a sample material in the form of a biological or chemical specimen wherein the specimen is collected and sealed in a specimen container for testing for a disease or other characteristic.

In one exemplary embodiment, the present disclosure provides a specimen container that may be used virtually anywhere including for use at a medical point-of-care facility, wherein the specimen container can receive a source material and can then enable the transfer of some of the source material to a processing device while substantially reducing exposure risks to the health care worker. In particular, the specimen container will receive a source material, in particular a sputum sample, from an individual. The specimen container includes a containing portion having a flexible wall and at least one opening.

The present disclosure also contemplates a processing device for detection of a disease, the processing device including a body configured to include a processing well, a fluid transport path, at least one heating element, a temperature sensing device and a covering. The processing well may be adapted to receive a device for mixing and pumping a source material. The fluid transport path may include a valve. The at least one heating element may be disposed proximate the processing well. The temperature sensing device may be disposed proximate the processing well. The covering may be placed over the processing well so that the contents of the processing well remain within the body.

The present invention provides a device and method for collection of a patient sample and separating the sample into various portions for further testing. The specimen container includes a containing portion having a flexible wall and at least one opening that may be sealed after specimen collection. In addition to the main body, the container may be comprised of at least one additional compartment in which some of the sample may be transferred internally and contained. More particularly, at least one compartment of the bag with some specimen may be isolated by forming at least one interior seal of the bag.

Without needing to re-open the bag, the compartmentalized aliquot(s) of the specimen may be physically separated from the main body. The compartmentalization is achieved through a variety of means, such as a mechanical interlock, heat sealing, pressure sensitive adhesive, or any combination thereof. The compartments may be pre-formed during the manufacturing of the collection bag, or formed subsequent to sample collection.

In a preferred embodiment, a port is present on a portion of the bag which can be sealingly attached to a processing device to transfer an aliquot of the specimen thereto for example diagnostic processing. Additionally, inclusion of ID tags to both to the main bag and the compartment may aid in sample tracking.

The invention herein contemplates a device and method for the collection, treatment and analysis of a source material wherein all collection, treatment and analysis steps may take place at one point-of-care medical facility. The diagnostic equipment disclosed herein may allow for the collection of the source material to be performed in a closed system with minimal transfer of source material and minimal technician participation so that risk of infection to health care workers is minimized. Collection of source material may occur so that the source material is sealed within a specimen container. The collection system may further allow for multiple sealed specimen compartments within a specimen container. All collection, treatment, and analysis may occur in a shortened time frame so that patients can provide a sample and receive a diagnosis in one trip to a health care facility.

### BRIEF DESCRIPTION OF THE DRAWINGS

FIG. 1 is a graphical, plan view of a specimen container according to an exemplary embodiment;

FIG. 2 is a graphical, plan view of the specimen container of FIG. 1 including a plurality of specimen sample compartments (ID tags) according to an exemplary embodiment;

FIG. 3A is a partial, graphical view of the specimen container of FIG. 2 detailing the specimen sample compartment of the sample container according to one exemplary embodiment;

FIG. 3B is a partial, graphical view of the specimen container of FIG. 2 detailing a alternate exemplary embodiment of the specimen sample compartment;

FIG. 4 is a graphical, plan view of a specimen container according to another exemplary embodiment;

FIG. 5 is a graphical, plan view of the specimen container of FIG. 4 showing a specimen sample compartments sealed and separated from the specimen container;

FIG. 6 is a graphical, plan view of a specimen container according to yet another exemplary embodiment;

FIG. 7 is a graphical, plan view of a specimen container having a plurality of specimen sample compartments according to yet another exemplary embodiment;

FIG. 8 is a graphical, plan view of a specimen container according to yet another exemplary embodiment having a specimen sample compartment sealed and separated using perforations;

FIG. 9 is a graphical, plan view of a specimen container according to yet another exemplary embodiment wherein the specimen sample compartment includes a port opening for transferring the specimen; and

FIG. 10 is a graphical, plan view of a specimen container according to yet another exemplary embodiment including an injection port.

### DETAILED DESCRIPTION

In general, this disclosure contemplates a device and method for the collection, and later treatment and analysis of a source material such as a biological or chemical specimen. The specimen container disclosed herein allows for the improved collection of the source material as well as the subsequent treatment and analysis. The collection occurs so that the specimen is sealed within the specimen container. The specimen container is particularly useful as it provides a closed system for collecting source materials so that risk of infection to health care workers and others is reduced and preferably minimized. The specimen container and method are designed such that source material collection is particularly useful and analysis of specimen may occur in an improved manner and in a shortened time frame so that a patient can provide a biological sample and receive a diagnosis in one trip to a health care facility. The specimen container disclosed is particularly useful in the collection and subsequent treatment and analysis may take place at one point-of-care medical facility.

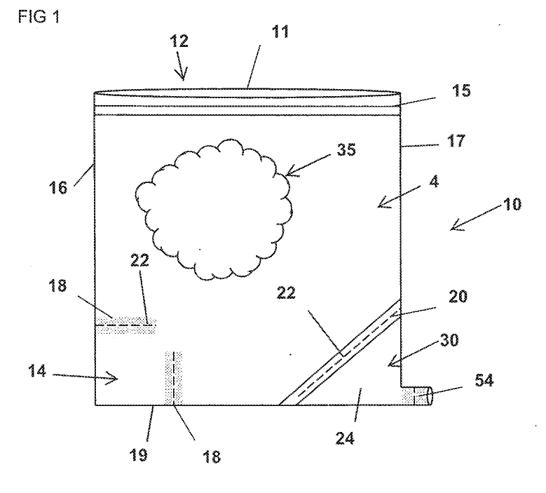

Referring generally to the drawings and in particular to FIGS. 1 through 3, a specimen container (or collection bag) 10 is shown constructed in accordance with the present disclosure. Collection and analysis of a source material which may include blood, saliva, sputum, tissue, feces, urine, semen, vaginal secretions, hair, tears, biopsy material, cerebral fluid, spinal fluid, bone material, or any other biological sample that may be tested for disease presence. In addition to health care-related specimens, the present invention is useful for testing other specimens or source materials (which may include or be found in textiles, soil, food, water, and mold). The collection of the specimen is accomplished utilizing the illustrated specimen container 10. The specimen container 10 is useful in the collection, analysis and determination of the presence of a particular disease (e.g., tuberculosis), or a particular substance in a person. In particular, the specimen container 10 is particularly useful to collect a specimen of sputum by having the person cough or expectorate into the opening 11. The opening 11 is formed along one edge of the specimen container 10 and provides a relatively large opening 11 having a periphery that a person can put over their mouth and cough and/or expectorate into the specimen container 10 while limiting and/or preventing the sputum or expectorate from escaping or missing the specimen container 10. Alternatively, the specimen container may include only one flexible wall onto which a source material is collected. The one flexible wall may then be folded upon itself and optionally sealed to contain the source material therein. This is particularly useful since the person is being tested for a disease, such as tuberculosis, and there is a very significant interest in avoiding further spread of the disease. In an alternate embodiment, the specimen container 10 is useful to collect other biological material including blood, saliva, sputum, tissue, feces, urine, semen, vaginal secretions, hair, tears, biopsy material, cerebral fluid, spinal fluid, bone material, or any other biological sample that may be tested for disease presence, which can also be deposited directly in the specimen container 10.

The opening 11 of the specimen container 10 is preferably located at or near a first side, edge or end 12 of the specimen container 10 to enable directly receiving the source material 35 within the specimen container 10 from the subject to be tested. The specimen container 10 further includes a second side, end or edge 16 and a third side, end or edge 17 that extend from the opening 11 and define a first portion 4. While the specimen container 10 of FIG. 1 is shown as having a relatively square shape that further includes the fourth side, end or edge 19, it will be understood that the specimen container 10 may have any known or appropriate shape including round, elliptical, triangular, quadrilateral and so forth. Additional functional shapes allow for the analysis of any source material 35 located therein without the need to know the amount thereof or the use of other implements which may become infected with any disease present in the sample 35.

Collection of a material sample in the form of a source material 35 such as sputum from an individual is accomplished by having the individual either cough and/or expectorate into the opening 11 of the specimen container 10. In one exemplary embodiment, as shown in FIG. 1, the specimen container 10 is preferably constructed of a flexible plastic material, such as a plastic bag having a seal 15 located proximal the opening 11, similar to a sealable plastic, sandwich bag made of an appropriate, medical purpose material for use as a specimen collection and testing device. The seal 15 is constructed from any known or appropriate sealable structure (such as a plastic zipper-type or interlocking element structure) and provides a fluid-tight seal to the specimen container 10. Alternative types of seal devices or methods, such as a heat seal or pressure sensitive adhesive seal, for sealing the specimen container 10 may also be used. Once the source material 35 is collected in the specimen container 10, the seal 15 can be closed (i.e., sealed shut) by the patient providing the source material 35.

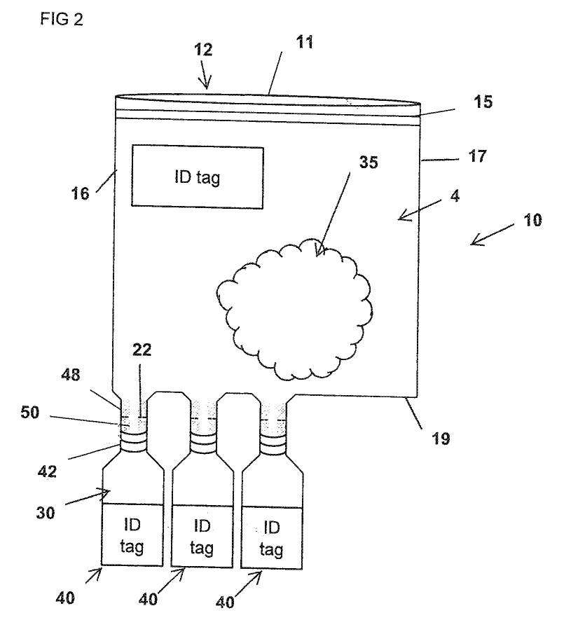

The specimen container 10 of the subject disclosure is intended to be a complete and closed system such that all features and functions are integral with the specimen container 10 and there is little or no need for manual tasks (such as a pouring, drawing or suctioning with a pipette, or scooping) to be performed with the seal 15 re-opened for sampling the source material 35 which further reduces the risks of exposure and contamination. Further, in one embodiment as best shown in FIG. 2, the specimen container 10 also includes areas for marking the specimen container 10 with unique identifier and/or patient information.

To further avoid a need for an additional device, the specimen container has a flexible wall, bag-type structure which allows the collected source material 35 to be moved within the specimen container 10. The source material 35 is moveable within the first and second portions of the specimen container 10 to prepare and/or subdivide (or apportion) the source material 35 into one or more specimen sample compartment 30. The specimen container 10 further includes a second (or lower) portion 14 which is divided or segmented from the first portion 12 of the specimen container 10 by at least one separator, wall, divider or seal 18. The first seal 18 extends laterally (as shown in FIG. 1) from the side 16 to a central location. A second seal 18 extends vertically (as shown in FIG. 1) from the side 19 in a direction toward the other seal 18. A second separator, wall, divider or seal 20 extends diagonally (as shown in FIG. 1) from the side 17 to the side 19 to define the specimen sample compartment 30.

Each separator, wall, divider or seal 18 and 20 may be made integral with the specimen container 10 similar to the seal 15 for closing the opening 11 or the seals 18 may alternatively be added or created at a later time, as desired. Each separator, wall, divider or seal 18 or 20 may include two appropriate sealable structures (such as a plastic zipper-type or interlocking element structure) that provide a fluid-tight seal on each side of the seal 18 and 20 locations. By sealing each portion of the specimen container 10, there is an improved containment of the source material 35 and a reduced likelihood of exposure and risk of infection to a healthcare worker and others who handle the specimen container 10 and the portions 14, 24.

To improve the usability and function of the specimen container 10, a tearable, removable or cutable structure, such as a line of etched or weakened spots or perforations 22 may be included between the sealable structures, as shown in FIG. 1, to make it easier to remove the portions 14 and 24 of the specimen container 10 for use in testing the part of the specimen 35 contained within each portion 14, 24. It should be understood that the specimen container 10 can be designed to have any number of portions therein and segmented using a seal 18 similar to the portions 14 and 24.

The source material 35 is apportioned among the main bag portion 4 and bag portions 14 and 24. While the specimen container 10 is designed so the opening 11 will properly and adequately receive the source material 35 in the portion 4, the specimen container 10 preferably has a flexible wall portion or structure, such as a plastic bag, so the source material 35 can be moved within the specimen container 10 by applying pressure to the bag of the specimen container 10 to force the source material 35 to be distributed though out the extent of the interior of the specimen container 10. It is possible to use any known or appropriate force generating mechanism to apply the pressure to move the source material 35. In one embodiment, pressure may be applied by the patient or a healthcare work using her hands or using a device. In an exemplary embodiment the specimen container is placed on a surface and a roller or other similar structure is used for applying pressure to the bag and moving the specimen 35 within interior of the main portion 4 of the specimen container 10 and toward the portions 14 and 24.

Once an acceptable portion of the source material 35 is located within the portions 14 and 24, the seals 18 and 20 can be completed. The specimen container 10 can be subdivided into a number of sealed and separated portions 14, 24 each of which contain at least a portion of the source material 35 for further testing and processing and the collecting or main portion 4 of the specimen container 10 can also be preserved or disposed in a more safe manner since it is also sealed by the seal 15 to limit and prevent others from contacting the portion of the source material 35 remaining therein. The disposable nature of all of the portions 4, 14, 24 of the specimen container 10 assists in improving the overall safety of the collection of the source material 35 as well as the related testing which reduces the risk of infection of healthcare workers and others that would traditionally come into contact with the patient during collection and testing for a disease.

In one exemplary embodiment, the bag of the specimen container 10 can be sealed using a heat source applied at any of the seal locations, including at the opening 11 at the one edge to close the specimen container 10 and create a fluid-tight seal and thereby preserve the integrity of the source material 35 before apportioning the specimen in the various portions of the bag of the specimen container 10. Alternative seal designs and means can be implemented by various known means such as heat or sonic staking or welding or pressure sensitive adhesive or mechanical interlock or other similar means or any combination thereof which may be automated or manually implemented.

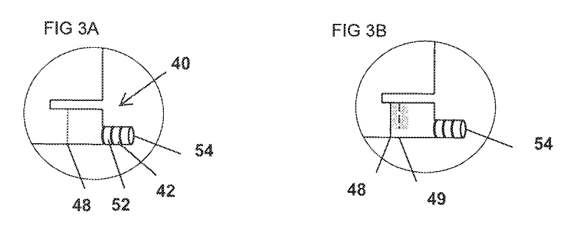

Further, the bag of the specimen container 10 may include any number of optional seals 18 located in any appropriate or alternative patterns disposed on the specimen container 10. In one alternative exemplary embodiment as shown in FIG. 2, the specimen container 10 includes a plurality of sample compartments 30 in the form of specimen sub-containers 40 which extend or depend from the side 19 of the specimen container 10. Each specimen sub-container 40 is coupled on one side to the specimen container 10, similarly to the portions 14 and 24, and includes a seal 48 in the form of a port 40 including a channel or passage 50 from the portion 4 of the specimen container 10. In the present embodiment, a portion of the specimen 35 is moved into the specimen sub-container 40 and then the seal 48 is completed and the specimen sub-container 40 may then be removed from the portion 4 by tearing, cutting, or similar operation along the seal 48. The seal 48 is sufficient so that after removal of the specimen sub-container 40, the contents of both the specimen subcontainer 40 and the portion 4 remain hermetically contained. As shown, a plurality of specimen sub-containers 40 may be provided on a given specimen container 10 for any variety of uses such as testing for multiple diseases, conducting different tests for the same disease, for preservation, or cataloging purposes. For example, in the case of suspected tuberculosis, multiple specimen sub-containers 10 may be employed, each for typical tests such as culture, smear microscopy, or PCR-based molecular diagnostics. The volume and interface for each specimen sub-container 10 may be different, giving consideration for the specific test to be done on the specific specimen sub-container 10. Each specimen sub-container 40 also preferably includes an identification (ID) tag portion, which allows for improved tracking and correct correlation of diagnostics results to the originating patient, especially in embodiments in which each specimen sub-container 40 is physically separated from the specimen container 10. In a further exemplary embodiment as shown in FIGS. 3A and 3B, the specimen sub-container 40 includes a threaded port 54. The specimen sub-container 40 includes a seal 48 similar to that of the embodiment of FIG. 2 so the specimen sub-container 40 can be separated from the portion 4 once a portion of the specimen 35 is located therein. Similarly, the seal 48 of specimen sub-container 40 of 3B may include a perforation line 22 at location near the seal 48 where the specimen sub-container 40 may be separated from the portion 4 of the specimen container 10. The port 54 of the specimen sub-container 40 is preferably sealingly interfaced with a container or processing device (not shown) prior to specimen collection. In this embodiment, the end of the port 54 is open and in fluid communication with the container or other processing device. In a further embodiment, the container or processing device may be integral to the specimen container 10. In another embodiment, the port 54 may be similar to a port access of an intravenous line and may be a piercable port for use with a syringe or needle or other puncturing structure as may be part of a testing device (not shown) for withdrawing a portion of the specimen 35 located within the specimen sub-container 40 and subsequent processing and testing of the specimen 35. In another alternative, the port 54 may be a positive pressure lock type port having a male or female connection for removably coupling to a female or male connection of another positive pressure lock type port for use in withdrawing the portion of the specimen 35 located in the specimen sub-container 40.

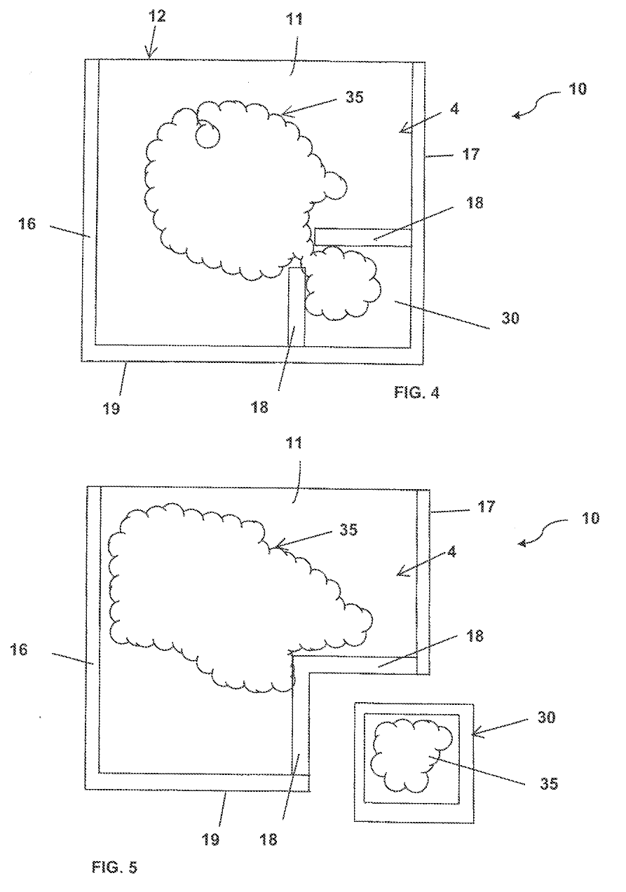

As noted above, the specimen container 10 may have shapes other than the rectangular shapes of the exemplary embodiments shown in the figures. In particular, the use of the sub-container 40 or the portions 14, 24 allow for a greater variety of alternative shapes for the specimen container 10 as well as allows for a variety of configurations useful for a greater variety of applications. For example, the specimen container 10 of FIGS. 4 and 5 is a relatively basic, single sample compartment 30 design. The sample compartment 30 is defined by two seals 18 extending toward each other from the sides 17 and 19 located at one corner of the rectangular bag of the portion 4. Once the specimen 35 is placed in the specimen container 10 through the opening 11, the opening 11 is sealed. The specimen 35 is then moved (via application of a force) within the specimen container to force at least a portion of the specimen 35 to move around the seals 18 and enter the sample compartment 30. Next, the space between the seals 18 is sealed closed and the sample compartment is then separated or detached from the main portion 4 of the specimen container 10 as best shown in FIG. 5.

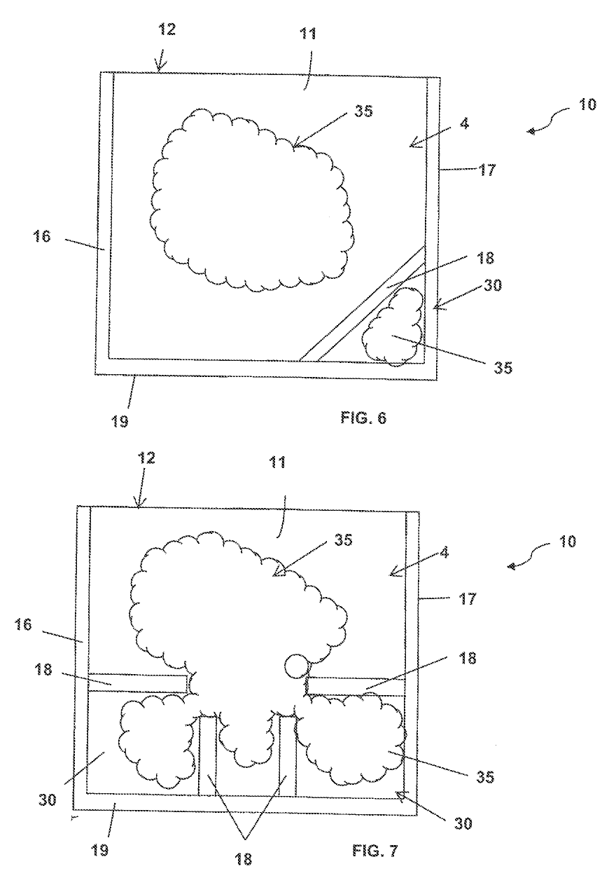

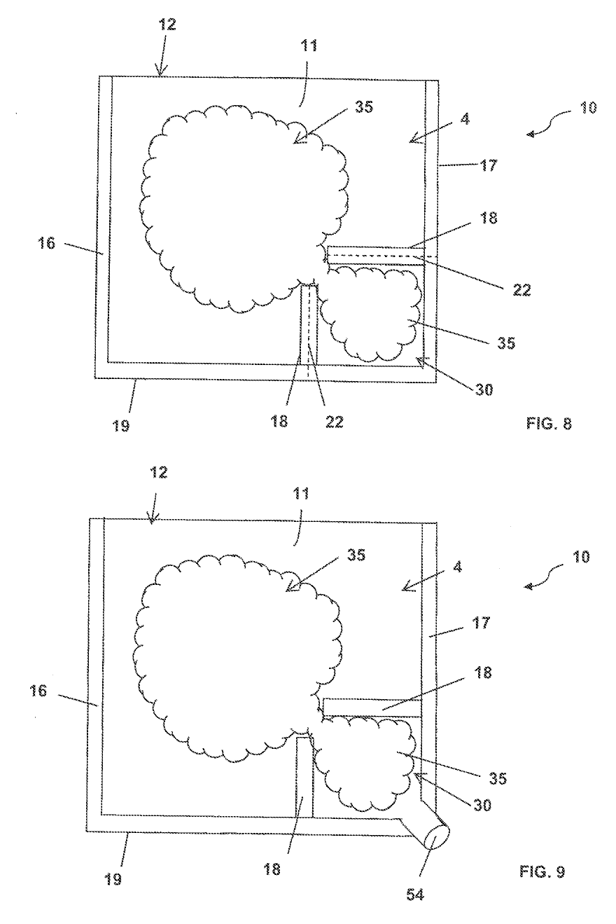

In the exemplary embodiment of FIG. 6, the sample compartment is defined by a single seal 18 extending diagonally from the side 17 to the side 19. In the exemplary embodiment of FIG. 7, two sample compartments are formed in the corners of the specimen container 10 which has a rectangular shape.

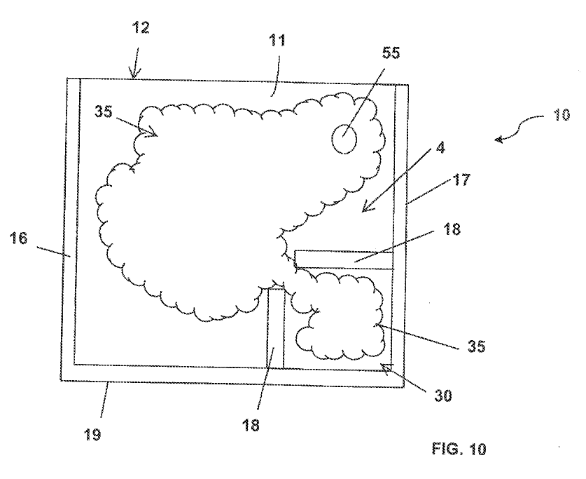

As best shown in FIG. 10, the specimen container 10 may also include additional components such as an insulating material to maintain heat within the specimen container 10 and a port 54 located within the portion 4 near the opening 11. The port 55 may be useful for adding a material to the source material 35 to affect the source material 35 in some required and/or desirable manner prior to a portion of the source material 35 being separated with the sample compartment 30.

Though not necessarily drawn to scale, geometries, relative proportions and dimensions shown in the drawings are also part of the teachings herein, even if not explicitly recited. However, unless otherwise stated, nothing shall limit the teachings herein to the geometries, relative proportions and dimensions shown in the drawing.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

We claim:

1: A specimen container, comprising:
a first portion including at least one flexible wall, at least one opening and at least one closed edge, the first portion for initially containing the specimen;
at least one sealing portion located along the at least one flexible wall;
a connector portion located along the at least one flexible wall for sealingly attaching the specimen container or portion of the specimen container to a processing device;
wherein, when sealed, the at least one sealing portion defines one or more sealed compartments.

2: The specimen container of claim 1, wherein upon sealing the sealing portion, the sealing portion seals the at least one opening to create at least two compartments.

3: The specimen container of claim 1, further including a separator for separating the compartment from the first portion of the specimen container.

4: The specimen container of claim 1, wherein the sealing portion is designed to be sealed by the application of heat, mechanical interlock, crimp, pressure, adhesive, or any combination thereof.

5: The specimen container of claim 1, wherein the specimen container is designed to be manipulated by force so that any specimen located in the specimen container is moved via the force into one or more portions of the specimen container.

6: The specimen container of claim 1, wherein the connector portion includes a thread, nozzle, valving mechanism, pierceable membrane, or any combination thereof.

7: The specimen container of claim 1, further including one or more chemical processing agents preloaded within the specimen container.

8: The specimen container of claim 1, wherein the sealing portion includes a mechanical interlock.

9: The specimen container of claim 1, wherein the sealing portion defines at least two compartments.

10: The specimen container of claim 1, wherein the sealing portion contacts the at least one closed edge.

11: A method for the transfer of a source material, the method comprising the steps of:
attaching a specimen container or a portion of a specimen container to a processing device whereby the specimen container is sealingly attached to the processing device;
collecting a source material from a patient so that the patient deposits the source material directly into the specimen container through an opening in the specimen container;
sealing the opening in the specimen container so that the source material is prevented from exiting the specimen container;
transferring a sample of the source material from the specimen container to the processing device so that the source material remains within the specimen container or the processing device; and
forming one or more compartments in the sealed specimen container.

12: The method of claim 11, wherein the step of forming the one or more compartments includes sealing a portion of the specimen container so that some or all of the source material is collected into a specimen compartment of the specimen container.

13: The method of claim 12, wherein prior to the step of sealing a portion of the specimen container is performed there is a step of applying a force to the specimen container to move the source material within the specimen container.

14: The method of claim 11, wherein the processing device is sealingly attached to the specimen container prior to any source material collection.

15: The method of claim 12, further including a step of detaching the specimen compartment containing the specimen from the specimen container.

16: The method of claim 12, wherein the specimen compartment containing some or all of the source material is attached to the processing device for transferring the source material to the processing device.

17: The method of claim 12, wherein any sealing step includes applying heat, mechanical interlock, crimp, pressure, adhesive, or any combination thereof to the specimen container to seal the specimen within the specimen compartment.

18: The method of claim 11, further including a step of contacting the source material with one or more chemical processing agents within the specimen container.

19: The method of claim 11, further including an additional sealing step for sealing the specimen container after transfer of the source material to the processing device.

20: A specimen container, comprising:
a first receiving portion for holding a source material, the first portion including an opening through which the source material is received, the opening being adapted to be hermetically sealed after receiving the source material so that the source material is isolated within the container and wherein at least a portion of the first receiving portion being defined by a flexible wall structure that contacts the source material and to which pressure can be applied for displacing at least a portion of the source material from the receiving portion to the expulsion portion; and
a specimen sample compartment in fluid communication with the first receiving portion and into which the source material can be transferred within the specimen container, the specimen sample compartment including a port through which the source material can be withdrawn from the container, the port being adapted for sealing connection with a specimen processing device, the specimen sample compartment being sealably detachable from the first portion.
